(19) United States
(12) Patent Application Publication
(10) Pub. No.: US 2023/0398556 A1
(43) Pub. Date: Dec. 14, 2023

(54) CENTRIFUGAL SCREW, AND SOLID BOWL SCREW CENTRIFUGE

(71) Applicant: FLOTTWEG SE, Vilsbiburg (DE)

(72) Inventors: Alfred Hiermer, Velden (DE); Lothar Fränkel, Gerzen (DE); Daniel Schroft, Gerzen (DE); Stefan Bichlmeier, Geisenhausen (DE)

(21) Appl. No.: 18/035,638

(22) PCT Filed: Nov. 9, 2021
(86) PCT No.: PCT/EP2021/081102

§ 371 Date: May 5, 2023

(30) Foreign Application Priority Data
Nov. 9, 2020 (DE) 102020129483.2

(51) Int. Cl. B04B 1/20

(52) U.S. Cl. CPC B04B 1/20; B04B 2001/2033; B04B 2001/2058

(57) ABSTRACT

The invention relates to a centrifugal screw (10) comprising a screw hub (15) and a screw flight (20) connected to the screw hub (15), the screw hub (15) having, in the longitudinal direction (R), at least one cylindrical longitudinal portion (11) and a portion (12) at the solid-discharge end. According to the invention, an open wall structure (40) is formed only in some sections of the cylindrical longitudinal portion (11), said open wall structure (40) in the cylindrical longitudinal portion (11) extending at most over a length (LW) of 50% of the total length (GL) of the cylindrical longitudinal portion (11).

The invention relates to a centrifugal screw for screw hub, and a screw spiral connected to the screw hub, wherein the screw hub in the longitudinal direction has a cylindrical longitudinal portion and a portion at the solid-discharge end according to the preamble of claim 1. Furthermore, the invention relates to a solid bowl screw centrifuge according to claim 12.

Solid bowl screw centrifuges are characterized by a drum having a closed or solid envelope. The drum is rotated at a high rotational speed, whereby a multiphase mixture located within the drum can be separated into a heavy phase and a light phase. The heavy phase usually is a solid phase transported out of the drum by a screw, i.e., a centrifugal screw. For this purpose, the screw is mounted within the drum to be rotatable relative to the drum and has a screw spiral. The screw spiral is arranged around a screw hub.

The screw spiral sweeps along the inner side or the inner envelope surface of the drum and thus conveys the product of the heavy phase to an axial end area of the drum. At the end of the drum, the product of the heavy phase is conveyed out from the drum. The multiphase mixture to be clarified hence is located between the inner side of the drum and the screw hub.

In certain solid bowl screw centrifuges, a large pond depth is aspired in particular for sewage clarification reasons. At the same time, however, the pond depth is limited by the diameter of the screw hub and buoyancy and deposition effects of the mixture to be clarified or the light phase.

From WO 2016/019944 A1, a solid bowl screw centrifuge having a screw hub is known which has a cylindrical portion having a grid structure. The cylindrical portion is completely formed by the grid structure. The grid structure essentially is formed by longitudinal rods so that the medium to be clarified can flow through openings between the longitudinal rods into the drum space or separating space. Such a structure which is only formed by longitudinal rods disadvantageously has insufficient torsion rigidity. Furthermore, high centrifugal forces act upon the longitudinal rods in operation so that the operating behavior of the screw hub is negatively influenced.

For increasing the rigidity of the screw hub, reinforcements in the form of transverse webs are used inside the cylindrical portion. Such transverse webs may only be installed under a high straightening and welding effort, wherein the entire costs in conjunction with the construction of the screw hub are increased. Since the transverse webs are arranged inside the cylindrical portion, the screw hub furthermore has declined material utilization.

The invention is therefore based on the task of providing a centrifugal screw which has higher rigidity due to an improved constructive structure and at the same time improved flow properties, and that can be produced in a simplified manner. The invention further is based on the task of proposing a solid bowl screw centrifuge.

According to the invention, this task is solved with respect to the centrifugal hub by the subject matter of claim 1. With respect to the solid bowl screw centrifuge, the task is solved by the subject matter of claim 12. The subclaims comprise at least appropriated configurations and further developments.

Specifically, the task is solved by a centrifugal screw having a screw hub and a screw spiral connected to the screw hub, wherein the screw hub in the longitudinal direction has at least one cylindrical longitudinal portion and a portion at the solid-discharge end.

The screw spiral can be connected directly to the screw hub. Connecting the screw spiral to the screw hub, for example, may be realized in the form of a material connection. Furthermore, it is possible for the screw spiral to be designed in one piece with the screw hub, so that connecting the screw spiral to the screw hub is already performed in the production process and when the individual components of the centrifugal screw are produced.

According to the invention, in the cylindrical longitudinal portion only in sections an open wall structure is designed, wherein the open wall structure in the cylindrical longitudinal portion at most extends over a length of 50% of the total length of the cylindrical longitudinal portion.

In such an embodiment of the cylindrical longitudinal portion the advantage is achieved, on the one hand, that an entry of the screw hub into the product to be clarified is enabled at least in sections. The flow properties within a solid bowl screw centrifuge are thus improved. On the other hand, a structure of the screw hub may be provided having an increased rigidity.

The longitudinal direction of the screw hub essentially is defined by the longitudinal axis of the screw hub. The longitudinal direction runs in parallel to the longitudinal axis of the screw hub. The longitudinal axis of the screw hub is that axis, around which the screw hub rotates when being used. The longitudinal axis of the screw hub may also be designated to be the rotational axis.

The longitudinal direction preferably is defined to be the direction of the transport of the solid material discharge.

In the longitudinal direction, the screw hub of the centrifugal screw according to the invention has at least two different portions. A first portion is the cylindrical longitudinal portion. A further portion is the portion at the solid-discharge end.

The portion at the solid-discharge end can form at least one end of the screw hub. It is also possible for the portion at the solid-discharge end to comprise an end of the screw hub.

In the cylindrical longitudinal portion, an open wall structure is only designed in sections. The open wall structure extends in the cylindrical longitudinal portion at most over a length of 50% of the total length of the cylindrical longitudinal portion. In other words, at least 50% of the total length of the cylindrical longitudinal portion are formed by another wall structure, preferably an essentially closed wall structure. A closed wall structure, for example, is a tube-shaped wall structure. The closed wall structure can have isolated openings. The proportion of isolated openings in the closed wall structure, however, is not as high as in the area of the open wall structure.

Such a wall structure has to be understood to be an open wall structure, which in the corresponding portion of the cylindrical longitudinal portion has a high number of openings and/or a large opening surface as a whole. In particular the sum of all single opening surfaces of single openings in the corresponding portion has to be understood to be an opening surface. In other words, the opening surface does not necessarily need to be a continuous single opening surface.

Preferably, the value of the opening surface is greater than the value of the closed surface. The closed surface has to be understood to be the portion of the wall structure that is closed and does not enable a material passage from the screw hub interior to the outside (and vice versa). Further preferably, in particular the sum of all single closed surfaces in the corresponding portion has to be understood to be the closed surface.

Furthermore and/or additionally, such a wall structure of the screw hub has to be understood to be an open wall structure which has a high proportion of openings in the radial direction. Preferably, the proportion of openings is higher than the proportion of closed surfaces. Preferably, the proportion of openings in the radial direction of the screw hub is at least 50%, further preferred at least 60%, particularly preferred at least 65% of the total wall structure in the radial direction.

Particularly preferred, the described proportion of openings in the radial direction is designed all throughout the total longitudinal extension of the open wall structure.

Preferably, only such a portion of the screw hub has to be understood to be a portion of the open wall structure which has at least one of the preceding proportions of the openings and/or closed surfaces.

The longitudinal extension has to be understood in the meaning of the invention to be an extension of a component, a portion etc. which runs essentially in the direction, of, preferably parallel to the longitudinal axis of the centrifugal screw and/or the solid bowl screw centrifuge.

In a preferred embodiment of the invention, the open wall structure in the cylindrical longitudinal portion extends at most over a length of 45% of the total length of the cylindrical longitudinal portion, in particular at most over a length of 35% of the total length of the cylindrical longitudinal portion, particularly preferred at most over a length of 25% of the total length of the cylindrical longitudinal portion.

In other words, 55% of the total length of the cylindrical longitudinal portion are designed to be a closed wall structure, in particular 65% of the total length of the cylindrical longitudinal portion, in particular 75% of the cylindrical longitudinal portion are designed to be a closed wall structure in the preferred embodiments.

The indicated ratios with respect to the proportion of an open wall structure at the cylindrical longitudinal portion represent optimum ratios with respect to an improvement of the flow properties to be achieved and the simultaneous improvement of the rigidity of the screw hub.

Preferably, the open wall structure in the cylindrical longitudinal portion extends over a length of at least 10% of the total length of the cylindrical longitudinal portion, in particular over a length of at least 15% of the total length of the cylindrical longitudinal portion, in particular over a length of at least 20% of the total length of the cylindrical longitudinal portion.

Further preferred, the open wall structure in the cylindrical longitudinal portion extends over a length of 10% to 45% of the total length of the cylindrical longitudinal portion, in particular over a length of 15% to 40% of the total length of the cylindrical longitudinal portion, further preferred over a length of 20% to 35% of the total length of the cylindrical longitudinal portion.

The indicated range specifications with respect to the extension of the proportion of an open wall structure at the cylindrical longitudinal portion represent optimum extension proportions with respect to an improvement of the flow properties to be achieved with the simultaneous improvement of the rigidity of the screw hub.

In a preferred embodiment of the invention, the open wall structure is spaced from the two ends of the screw hub. Particularly preferred, the open wall structure is designed to be a middle segment. In such an embodiment of the invention, the open wall structure is designed to be essentially between the portion at the solid-discharge end of the screw hub and the end the screw hub opposite the portion at the solid-discharge end.

In a further embodiment of the invention, the middle segment and/or the open wall structure may be designed so as to be spaced from the portion at the solid-discharge end. In such an embodiment of the invention, the open wall structure is designed to be within the cylindrical longitudinal portion such that the cylindrical longitudinal portion itself has two portions having a closed wall structure, wherein the middle segment is designed between the two portions having a closed wall structure.

In other words, it is possible for the open wall structure to be designed between a first portion of a closed wall structure and a second portion of a closed wall structure. Such an embodiment, on the one hand, enables a particularly high bending and torsional rigidity. On the other hand, the screw hub can immerge in the area of the open wall structure into the material to be processed. In such an embodiment of the invention, the portion having a closed wall structure pointing towards the portion of the screw hub at the solid-discharge end of the screw hub, preferably is shorter than the portion of the screw hut having the closed wall structure which points towards the second end of the screw hub.

In a further embodiment of the invention, it is possible for the open wall structure to be designed to be such a middle segment which is arranged in particular in the area of the perpendicular dividing the total length of the screw hub in two equally dimensioned portions. In other words, the described perpendicular is located in the middle segment of the screw hub.

It is furthermore possible for the open wall structure to have a larger outer diameter than neighboring portions of the screw hub. It is in particular possible for the open wall structure to have the largest outer diameter of the screw hub. In such an embodiment of the invention, the open wall structure may immerge deeper into the medium to be clarified or separated within the drum space or separating space.

In other words, the open wall structure may project or protrude beyond the outer diameter of the neighboring portions of the screw hub. In such an embodiment of the invention, the open wall structure preferably is formed of longitudinal rods, so that the longitudinal rods of this open wall structure project beyond the wall structure of the neighbouring portions. The neighbouring portions of the screw hub may in particular be partial areas of a closed wall structure. Furthermore, it is possible for a neighboring portion of the screw hub to be the portion at the solid-discharge end of the screw hub in this embodiment.

A ratio of a/the outer diameter of the open wall structure to the outer diameter of the screen spiral is preferably 0.8-0.4, in particular 0.7-0.4, particularly preferred 0.4. The outer diameter of the screw spiral is related to the outer diameter of the centrifugal screw which is formed by the spital tip of the screw spiral lying radially outside.

In the embodiment of the invention according to which the open wall structure has a larger diameter than neighboring portions of the screw hub, the ratio of the outer diameter of the open wall structure to the outer diameter of the screw spiral may be 0.8-0.6, in particular 0.7-0.6, particularly preferred 0.6.

In particular it is possible for the explained larger outer diameter to be designed substantially only in the portion of the cylindrical longitudinal portion which has the open wall structure.

For attaching or connecting the open wall structure having an increased or larger outer diameter to the neighboring portions of the cylindrical longitudinal portion, the increased outer diameter may also be designed at the respective adjacent ends of the neighboring portions of the cylindrical longitudinal portion. These attaching or connecting areas, however, should be kept as low as possible. In particular, the longitudinal extension of the respective (single) attaching or connecting areas should maximally be 20% of the total longitudinal extension of the area having an increased or larger outer diameter, maximally be 15% of the total longitudinal extension of the area having an increased or larger outer diameter, maximally be 10% of the total longitudinal extension of the area having an increased or larger outer diameter, maximally be 5% of the total longitudinal extension of the area having an increased or larger outer diameter.

The indicated specifications with respect to the maximum longitudinal extension of the attaching or connecting areas represent optimum longitudinal extension proportions with respect to an improvement the flow properties and separating action to be achieved with respect to the area having an increased or larger outer diameter while simultaneously enabling a sufficient attachment of the open wall structure to the neighboring portions of the of the cylindrical longitudinal portion.

The indicated ratios show that the open wall structure is positioned to be relatively close to the spiral tip of the screw spiral. In case of such a ratio of the outer diameter of the open wall structure to the outer diameter of the screw spiral, a particularly deep immersion of the screw hub into the mixture to be clarified or separated can be performed.

The open wall structure may be formed by means of several rods running in the longitudinal direction of the screw hub. The rods running in the longitudinal direction preferably are arranged on an imaginary circle. In an embodiment of the invention, the diameter of the imaginary circle corresponds to the diameter of the neighboring portions of the screw hub.

When such an open wall structure having a larger diameter than neighboring portions of the screw hub is designed, the imaginary circle may have a larger diameter than the outer diameter of the neighboring portions of the screw hub.

Such a portion of an open wall structure may be designed such that the longitudinal rods at their ends each are attached to a kind of transverse disc. It is also possible for the longitudinal rods to be attached to a kind of a kind of transverse disc at one end.

Furthermore, it is possible for the longitudinal rods to be attached at their ends to neighbouring portions of the screw hub. In this case, the transverse discs may represent a supporting completion of the two neighboring portions of the screw hub.

It is possible for the two transverse discs to be designed as closed discs. Furthermore, it is possible for at least one of the transverse discs to be designed as a closed transverse disc. This concerns both the case in which the longitudinal rods are connected at least on one side to a transverse disc and the case in which the longitudinal rods are attached on both sides to neighboring portions of the screw hub.

Again, it is possible for a transverse disc to have a passage opening if the wall structure is designed in an inlet area of the centrifugal screw. This passage opening, for example, may serve for passing through an inlet tube.

It is possible for the open wall structure to have a transverse disc. Such a transverse disc may be designed such that at least in sections at least one opening is designed at 75% of all of the imaginary circle lines of the transverse disc from the center point to the transverse disc circumference. The imaginary circle lines are all circle lines that can be designed in the radial extension between the center point to the transverse disc circumference.

Preferably, in the theoretical or imaginary configurations only a distance of 5 mm, in particular of 2 mm, in particular of 1 mm, in particular of 0.5 mm is designed between the circle lines. In such an observation of the circle lines, the distance between the circle lines preferably is designed to have the same size.

Such a disc is to be understood to be a transverse disc of a centrifugal screw which is designed to be transversely to the screw hub. The transverse disc in particular serves for stabilizing the screw hub or the part of the screw hub that has an open wall structure. A transverse disc may also be referred to be a supporting disc.

Starting from the center point towards the transverse disc circumference, the transverse disc has imaginary circle lines. At least on 75% of all of the imaginary circle lines, an opening or a portion of an opening is designed at least in sections.

In other words, in at least 75% of the total diameter range of the transverse disc, throughout the respective diameter, an opening or at least a partial portion of an opening is designed at least in sections. In other words, on least 90% of all diameters of the transverse disc, throughout the respective diameter, at least one opening or at least a partial portion of an opening is designed at least in sections.

In a further embodiment of the invention, in at least 85% of the total diameter range of the transverse disc, throughout the respective diameter, an opening or at least a partial portion of an opening is designed at least in sections. In other words, on at least 85% of all diameters of the transverse disc, throughout the respective diameter, at least one opening or at least a partial portion of an opening is designed at least in sections.

In a further embodiment of the invention, in at least 90% of the total diameter range of the transverse disc, throughout the respective diameter, an opening or at least a partial portion of an opening is designed at least in sections. In other words, on at least 90% of all diameters of the transverse disc, throughout the respective diameter, at least one opening or at least a partial portion of an opening is designed at least in sections.

In a further embodiment of the invention, at least one opening or at least a partial portion of an opening is designed throughout the total diameter range of the transverse disc at least in sections, throughout the respective diameter. In other words, on all of the diameters of the transverse disc, throughout the respective diameter, at least one opening or at least a partial portion of an opening is designed at least in sections.

Such a configuration of openings throughout a large part of the diameter range of the transverse disc enables the liquid or centrate in the area of the screw hubs to flow off well. At the same time, such a transverse disc has sufficient rigidity so that the transverse disc continues to cause the screw hub to be stabilized well.

In an embodiment of the invention, in particular a diameter range of the transverse disc which delimits a central middle opening of the transverse disc may be designed to be without opening(s). Such a portion free from opening(s) may benefit the additional stability of the transverse disc.

In a particularly preferred embodiment of the invention, an opening or a portion of an opening is designed on all imaginary circle lines of the transverse disc at least in sections. In other words, particularly preferred throughout the total diameter range of the transverse disc, at least an opening or at least a partial portion of an opening is designed with respect to each diameter.

It is possible for the transverse disc to be constructed such that the liquid or the centrate is enabled to flow off throughout the total diameter range of the transverse disc.

Preferably, the openings of the transverse disc are designed such that these openings have different geometries and/or opening sizes and/or arrangement patterns.

The shape of the opening is to be understood to be the geometry of an opening. It is possible for the transverse disc to have several openings having different geometries.

In other words, the opening size of an opening relates to the opening surface. Throughout the opening size, the liquid may pass and/or flow off. It is possible for the openings to have different dimensions with respect to the opening sizes.

The arrangement of several openings has to be understood to be the arrangement pattern, wherein at least two openings form an opening group, wherein several opening groups can be arranged to be distributed over the transverse disc. It is furthermore possible for the transverse disc to have a group of openings forming evenly distributed openings throughout the transverse disc. Preferably, a group of openings is formed by several openings designed to be similar. Openings have to understood to be similar openings which have the same geometry and the same diameter surface.

In an embodiment of the invention, the transverse disc has several openings designed to be cam-shaped or ovoid or elliptical. Preferably, such openings are arranged in pairs. A pair of such openings thus forms an opening group. Several of such opening groups in turn may be evenly arranged throughout the transverse disc.

Such an opening has to be understood to be a cam-shaped opening which essentially has the shape, in particular the cross-sectional shape of a cam of a camshaft. In particular, such an opening has the shape of a steep cam. In other words, such an opening is formed by two circular segments, the radial center points of which lie on a common mirror axis of the opening. The circular segments in turn are connected in sections by straight lines.

It is furthermore possible for the openings to be designed to be ovoid or elliptical. In a particularly preferred embodiment of the invention, two of such openings respectively are arranged relative to one another such that they form an opening group.

In a particularly preferred embodiment of the invention, in each case six openings are designed to be ovoid or elliptical, wherein two openings respectively form an opening group. The three opening groups thus formed are evenly distributed on the transverse disc in the circumferential direction.

Furthermore, starting from the transverse disc circumference, the transverse disc may have several openings which are designed as recesses of the transverse disc circumference.

These recesses preferably are designed to be U-shaped.

Preferably, such recesses, in particular U-shaped recesses, in turn are arranged in pairs. In a particularly preferred embodiment, the transverse disc has six such recesses, in particular six such U-shaped recesses. Two of the recesses form an opening group. The three opening groups such formed are arranged evenly in the circumferential direction of the transverse disc. In the circumferential direction, one opening group formed of U-shaped recesses preferably respectively alternates with an opening group formed of cam-shaped openings.

Preferably, the U-shaped recesses have such a length in the direction of the center point of the transverse disc that the U-shaped recesses in the radial extension starting from the center point to the transverse disc circumference at least in sections lie on corresponding circles lines to the openings that are designed to be cam-shaped.

It is moreover possible for the transverse disc to have several openings that are designed to be circular.

Preferably, the opening designed to be circular are arranged in pairs. In other words, two circular openings form an opening group.

In turn preferably, six openings designed to be circular are formed. Six such openings can form three opening groups having a circular shape. The opening groups in turn are arranged evenly on the transverse disc in the circumferential direction.

In addition, its is possible for the transverse disc to have several different embodiments of circularly designed openings. For example, a first type of circularly designed openings may be arranged as opening groups. A second type of circularly designed openings may each be arranged as individual opening.

In a further preferred embodiment of the invention, an opening group of circular openings and an opening group made up of U-shaped recesses are formed in the same circular segment. The opening group with circular openings is formed inwardly, i.e., toward the center point.

In a preferred embodiment of the invention, the transverse disc is formed by six circular sectors, three circular sectors each comprising the groups of openings with cam-shaped openings, and three circular sectors each comprising one opening group formed by circular openings The circular sectors formed in this way are each alternately formed.

On the circumference of the transverse disc, recesses can be formed, preferably essentially semicircular, which are arranged to be uniformly distributed. The recesses, in particular having a semicircular shape, can be used in particular to accommodate longitudinal rods which, for example, in sections form the screw hub construction or are part of a central segment.

Furthermore, it is possible for the recesses formed on the circumference of the transverse disc to have such a shape that web elements of the wall structure of the screw hub engage or can engage into the recesses. Furthermore, it is possible for the recesses formed on the circumference of the transverse disc to have such a shape that tube wall sections of the screw hub can engage into the recesses.

In the center point of the transverse disc, an opening may additionally be designed. The center point opening can have a circular shape having additionally further circle segment-like recesses, in particular three circle segment-like recesses. Such a recess has to be understood to be the circle segment-like recess which is formed of a circle segment, wherein the circle segment is the partial surface of a circle surface delimited by a circular arc and a chord.

The circle segment-like recesses, in particular the three circle segment-like recesses, preferably are designed evenly in the circumferential direction around the circular shape of the center point opening such formed.

In a further embodiment of the invention, it is possible for the circle segment-like recesses, in particular the three circle segment-like recesses, to be arranged in the transverse disc such that in each case one opening group formed of two circularly designed openings, and one circle segment-like recess of the center point opening alternate.

Preferably, three opening groups each formed by two circularly designed openings, and three circle segment-like recesses are designed. Preferably, it is provided for at least one imaginary circle line of the transverse disc to intersect both the circle segment-like recesses and the opening groups each formed of two circularly designed openings.

In a further embodiment of the invention, the openings may also have a diamond-shape and/or a polygon shape and/or a pointed arch shape and/or a triangle or rectangle shape having bent sides at least in sections.

Between the single openings of the transverse disc, the material of the transverse disc is designed. This material preferably is formed of metal.

In a possible embodiment of the invention, the openings have such a size and are arranged relative to one another so that the material of the transverse disc is designed to be web-like. The webs may be designed to be straight and/or arc-shaped. When webs are designed, a particularly advantageous ratio of opening sizes in relation to the remaining material of the transverse disc is created.

In a further embodiment of the invention, the open wall structured is formed by a plurality of web elements delimiting a plurality of openings, wherein the web elements with respect to the longitudinal axis of the screw hub are arranged to be radially outside and form a circumference of the cylindrical longitudinal portion, wherein two web elements each form a web pair delimiting at least one opening, wherein the two web elements of the web pair extend in the longitudinal direction and transversely to the longitudinal direction, or a first web element of the web pair respectively extends in the longitudinal direction, and a second web element of the web pair extends transversely to the longitudinal direction.

An open wall structure formed by a plurality of web elements has the advantage that such an open wall structure has a particularly good stability. The bending or torsional rigidity of a centrifugal screw produced in this was is particularly high.

In a further embodiment of the invention, the open wall structure is formed by a tube at least in sections, in which a plurality of openings is designed for the passage of a medium, wherein the openings each have a longitudinal extension which is greater than a width of the respective opening.

Such an embodiment of the invention has the advantage that the open wall structure as compared to the closed wall structure does not have large constructional differences. Such a shape of an open wall structure may be produced simply, since in a previously completely closed wall structure such openings can be introduced so that a wall structure is formed which is open in sections.

It is possible for the portion at the solid-discharge end to have a cone shape or a double truncated cone shape or is designed as a cylinder portion or a cylindrical tube portion. In dependence of the material to be processed, the portion at the solid-discharge end thus may have different shapes. When the portion at the solid-discharge end is designed in a cone shape, such a shape or geometry is selected that is particularly widespread. In this respect, a particularly simple, standardized production of the portion at the solid-discharge end is possible.

It is possible for the portion at the solid-discharge end to be designed as a cylinder portion and/or cylindrical tube portion. In particular such a portion has to be understood to be such a cylinder portion and/or cylindrical tube portion which has a tube, wherein the tube, for example, is attached to the cylindrical longitudinal portion by means of a connecting flange. Such a cylinder portion is designated to be a tube in the following which is designed to be hollow at least in sections.

By means of such an embodiment of the portion at the solid-discharge end of the screw hub, such a screw hub and thus such a centrifugal screw may be provided that contributes in a particularly advantageous manner to reducing bottlenecks in the direction of the solid material discharge. Such bottlenecks are known in a solid bowl screw centrifuge. These are known in the area of the transition from a cylindrical longitudinal portion to a discharging portion.

The drum of a solid bowl screw centrifuge in most cases has a cone shape in this portion. By designing a cylinder portion and/or cylindrical tube portion, an increased volume is provided within the drum in the area of the solid material discharge or in the area of the last dwelling path of the solid material to be transported. This thus results in reducing known bottlenecks. Due to that, high solid material freights may be transported during processing of a material or medium to be separated in a certain temporal specification.

A further advantage in designing the portion at the solid-discharge end as a cylinder portion and/or cylindrical tube portion is that the solid material is present in a relaxed shape. This also applies to such a solid material that has possibly already been compressed during processing. Such a relaxed solid material forms in rarer cases clumps at the solid material discharge and is present in a free-flowing shape. Due to the reduced forces acting upon the portion at the solid-discharge end, such an embodiment is particularly low-wear.

Moreover, no sedimented particles descending from the mixture to be clarified toward the drum inner side adhere on the longitudinal portion of the screw hub. The sediment particles rather flow off into the outer area of the drum.

By means of the screw hub according to the invention, a large pond depth may be constructed in conjunction with a solid bowl screw centrifuge, wherein improvements in the field of the solid material discharge are achieved at the same time.

It is possible that the cylinder portion and/or the cylindrical tube portion is formed to be stepped such that the cylinder portion and/or the cylindrical tube portion in the longitudinal direction of the screw hub have/has at least two portions having different diameters.

By means of such a step shape, an again improved reduction with respect to the undesired generation of bottlenecks can be achieved. At the same time, the solid material to be transported and discharged may also be further relaxed.

The at least two portions of the cylinder portion and/or the cylindrical tube portion preferably are arranged such that the portion having a smaller or minimum diameter is designed to be spaced further from the cylindrical longitudinal portion than the cylinder portion and/or the cylindrical tube portion having a larger or maximum diameter. The step-shaped realization of the cylinder portion and/or the cylindrical tube portion preferably is performed such that the diameters of the portions are reduced in a step-wise manner in the direction of the frontal side of the screw hub associated to the portion at the solid-discharge end.

It is possible in a further embodiment of the invention that the portion at the solid-discharge end has a double truncated cone shape. The double truncated cone shape preferably is designed such that the imaginary surface areas of two truncated cones adjoin each other.

The double truncated cone shape preferably is designed such that the maximum diameter of the double truncated cone shape neither is formed at a connecting portion to the cylindrical longitudinal portion nor at a frontal side of the screw hub associated to the portion at the solid-discharge end.

A first cover surface of a first truncated cone of the double truncated cone shape is arranged in a connecting portion and/or a transition area to the cylindrical longitudinal portion of the screw hub.

A second cover surface of the second truncated cone of the double truncated cone shape is designed at the frontal side of the portion at the solid-discharge end or pointing into the direction of said frontal side.

It is possible for the truncated cones forming the double truncated cone shape to have the same height. In such an embodiment of the invention, the double truncated cone shape is designed to be axially symmetric. The axis of symmetry is formed in the area of the superimposed surface areas of the two truncated cones.

In a further embodiment of the invention, the truncated cones forming the double truncated cone shape have different heights. The truncated cone being designed adjacent to the cylindrical portion preferably has a lower height than the second truncated cone pointing into the direction of the frontal side of the screw hub.

By means of designing the portion at the solid-discharge end in the form of a double truncated cone, fine substances of materials to be processed and already separated phase-wise, may be better separated again.

In a further embodiment of the invention, the open wall structure may be designed in an inflow area of the centrifugal screw, wherein an inflow tube opening of an inflow tube opens into the inflow area. Here, a baffle element, in particular a baffle disc having an acceleration element is designed opposite the inflow opening, wherein the acceleration element is designed such that a medium impinging on the acceleration element can be accelerated in the direction of openings of the open wall structure.

Since in this embodiment of the invention, the inflow area is not designed as in the classical sense as an inflow chamber having corresponding massive and mostly closed walls, but, for example, is designed itself by single segments, in particular longitudinal rods of the screw hub, the openings of the open wall structure themselves may serve as openings of the inflow chamber.

It is possible for the inflow tube to extend into the direction of the inflow area starting from the portion at the solid-discharge end of the screw hub.

The acceleration element preferably has baffle surfaces placed transversely to the rotational axis of the centrifugal screw. Due to the acceleration element being designed, the baffle element or the medium impinging the acceleration element may be pre-accelerated relatively low in turbulences in a caring manner.

The acceleration is performed in the direction of the openings of the open wall structure. Only then the medium enters through the openings into the drum inner space or into the separation space, when the screw hub or the centrifugal screw is rotating.

The acceleration element essentially is designed as a protrusion pointing into the direction of the inflow tube opening. It is possible for the protrusion to be arranged on a disc or plate. The disc or plane can be designed to be planar or arched.

Together with the disc or plate, the protrusion may form an autonomous component which can be produced separated from the baffle element, in particular the baffle disc. This facilitates, for example, a baffle element to be subsequently equipped with the acceleration element.

In a further embodiment of the invention, it is possible for the protrusion to be attached directly on the baffle element, in particular the baffle discs. This enables material to be saved.

In an embodiment of the invention, the acceleration element has struts which are in particular arranged relative to one another in a cross-shape. It is also conceivable for several webs to form a start shape in a top view to the acceleration element. In such an embodiment of the invention, the protrusion is formed by an arrangement of struts.

In an embodiment of the invention, it is possible for the height of the struts to increase in the direction of a point of intersection. As the height of the struts, the relative distance to the baffle element, in particular to the baffle disc—if designed—is understood to be the relative distance from the separate disc or plate.

Preferably, the acceleration element is arranged on the baffle element such that a point of intersection and/or a highest point of the acceleration element is designed to be flush to the center point of the baffle element, in particulate the baffle disc. In other words, the point of intersection and/or the highest point of the acceleration element is arranged on the longitudinal axis of the centrifugal screw.

In a further or alternative embodiment of the invention, the acceleration element may be designed as a protrusion projecting from the baffle element and pointing in the direction of the inflow tube opening. This protrusion has several radial flanks. Such flanks are to be understood to be radial flanks which run into the direction of the baffle element starting from a centrally arranged central point. Preferably, the radial flanks are arranged to be evenly arranged or evenly spaced from one another in the circumferential direction of the protrusion.

Moreover, it is possible for channels to be designed between the flanks, wherein the channels may have a swirling course. If a medium impinges such an acceleration element, the medium will be deviated an accelerated along the channels in the direction of the baffle element and in the direction of the free spaces. The channels and/or flanks are evenly distributed over the protrusion.

It is possible for the acceleration element to be formed as a protrusion which protrudes from the baffle element and points into the direction of the inflow tube opening, and which has several, for example, four baffle surfaces arranged transversely to the longitudinal axis of the inflow area. The longitudinal axis of the inflow area is in particular the rotational axis of the centrifugal screw.

The baffle surfaces, for example, may be arranged to one another such that the protrusion has a pyramid-like shape. The pyramid tip may in particular be designed to be flattened.

The spiral coil of the centrifugal screw preferably is evenly designed in the same longitudinal portion. This may concern both the thickness of the screw spiral and the outer diameter as well as the pitch of the spiral.

It is moreover possible for the screw spiral to be designed conical in the area of the portion at the solid-discharge end.

In the cylindrical longitudinal portion in the area of the portions having a closed wall structure, the screw spiral can be connected completely to the outer surface of these portions.

The screw spiral in the area of the open wall structure is only connected in sections to the open wall structure. This concerns in particular the parts of the wall which are designed between single openings of the open wall structure.

The screw spiral preferably is arranged circumferentially to the screw hub. Preferably, the screw spiral is designed over the entire or almost over the entire or total longitudinal extension of the screw hub.

In other words, the screw spiral preferably is arranged at the cylindrical longitudinal portion of the screw hub and on the portion at the solid-discharge end of the screw hub.

A further subordinate aspect of the invention is related to a solid bowl screw centrifuge comprising a centrifugal screw located withing a drum, wherein the centrifugal screw is designed according to the invention.

With respect to the solid bowl screw centrifuge, reference is made to the advantages explained in conjunction with the centrifugal screw.

Furthermore, the solid bowl screw centrifuge may alternatively or additionally have single features or a combination of features previously mentioned with respect to the centrifugal screw.

The invention will be explained in more detail below on the basis of further details while referring to the attached drawings.

The illustrated embodiments represent examples how the centrifugal screw may be designed.

In these is shown:

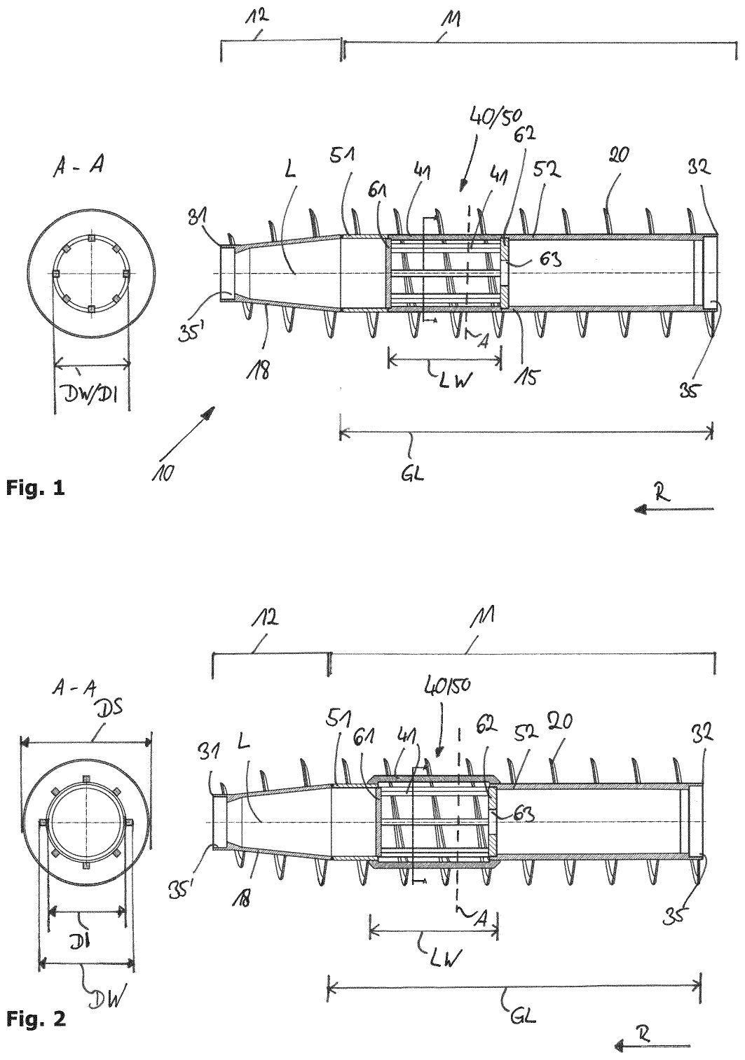

FIG. 1 a longitudinal section through a centrifugal screw according to a first exemplary embodiment; and

FIG. 2 a longitudinal section through a centrifugal screw according to another exemplary embodiment according to the invention.

The same reference numerals are used in the following for the same parts or parts having the same action.

A centrifugal screw 10 having a screw hub 15 is illustrated in FIG. 1. The screw hub in the longitudinal direction R, has a cylindrical longitudinal portion 11 and a portion 12 at the solid-discharge end.

The longitudinal direction R runs essentially in parallel to the longitudinal axis L of the screw hub 15. The longitudinal R is defined in the following case as the direction of the transport of the solid material discharge. The solid material transport according to the illustration of FIGS. 1 and 2 is performed from the right to the left side.

The centrifugal screw 80 moreover comprises a screw spiral 20.

The cylindrical longitudinal portion 11 is designed to be longer than the portion 12 at the solid-discharge end. The portion 12 at the solid-discharge end of the screw hub is to be understood to be such a functional portion which serves in particular the transport of the solid material separated from the material to be processed in the direction R of the solid material discharge.

An open wall structure 40 is only designed in sections in the cylindrical longitudinal portion. The open wall structure 40 is formed by several rods 41.

As shown in the left cross-sectional representation of FIG. 1 according to section A-A, the rods 41 are arranged distributed in even distances over the circumference of the screw hub 10, in the longitudinal direction R thereof, thus in parallel to the longitudinal axis. In the present case, the open wall structure 40 is formed of eight rods 41. The number of the rods 41 can vary and be inter alia differently configured in dependence of the diameter of the screw hub 15.

The open wall structure 40 may also be formed, as explained in the previous description, by web elements, specifically web pairs.

Alternatively, it is possible for the open wall structure 40 to be formed by a tube in which a plurality of openings is designed for the passage of a medium.

The cylindrical longitudinal portion 11 extends from a second frontal side 32 of the screw hub 15 up to the start of the portion 12 at the solid-discharge end.

The portion 12 at the solid-discharge end is formed in the present case by a cone-shape 18. The portion 12 at the solid-discharge end in addition comprises the first frontal side 31 of the screw hub 15.

Moreover, bearing portions 35 and 35′ are designed for supporting the illustrated centrifugal screw 10 in a drum (not illustrated) of a solid bowl screw centrifuge (likewise not illustrated).

The open wall structure 40 extends in the cylindrical longitudinal portion 11 at most over a length LW, wherein this length LW amounts to at most 50% of the total length GL of the cylindrical longitudinal portion 11.

In the illustrated example, the open wall structure 40 is designed between a first portion 51 of a closed wall structure and a second portion 52 of a closed wall structure. Such an embodiment, on the one hand, enables a particularly high bending and torsional rigidity. On the other hand, the screw hub 15 can immerge in the area of the open wall structure 40 into the material to be processed.

Embedding the open wall structure 40 between two portions 51 and 52 having a closed wall structure facilitates attaching the open wall structure 40 in the area of the screw hub 15.

The open wall structure 40 is spaced from the two ends or the two frontal sides 31 and 32 of the screw hub 15. The open wall structure 40 designs a kind of middle segment 50, since the middle segment 50 is designed both between two portions 51 and 52 of the cylindrical longitudinal portion 11 as well as surrounds a perpendicular A. In other words, the perpendicular A is designed in the area of the middle segment 50. The perpendicular A is the perpendicular A which is designed to be perpendicular to the longitudinal axis L and bisects the screw hub 15 with respect to its length in the longitudinal direction R.

The rods 41 of the open wall structure 40 are attached to two transverse discs 61 and 62. The first transverse disc 61 is a completely closes transverse disc 61. This prevents inter alia that the material to be processed can penetrate into the interior space of the portion 12 at the solid-discharge end. It is moreover possible for a kind of acceleration element to be designed on the transverse disc 61. This is in particular advantageous if the open wall structure 30 forms at the same time the inflow area of a screw bub 15.

The second transverse disc 62 has an opening 63. Through this opening 63, an inflow tube, for example, may be guided so that the material to be processed can flow through the open wall structure 40 to the outside into the drum interior.

In the present case, an inflow tube (not illustrated) would run starting from the second frontal side 32 in the direction of the opening 63 of the second transverse disc 62.

Alternatively, it is possible for an inflow tune to run starting from the first frontal side 31 in the direction of the open wall structure 40. In such a case, the transverse discs 61 and 62 each should be inversely designed as illustrated in FIG. 1, i.e., at the position of the illustrated first transverse disc, such a transverse disc having an opening would have to be designed.

According to the cross-sectional representation of FIG. 1, it is clear that the outer diameter DW of the open wall structure 40 has such a value that corresponds to the outer diameter DI of the neighboring portions 51 and 52 of the screw hub 15.

In FIG. 2, a further embodiment of the centrifugal screw 10 according to the invention is illustrated. The difference from the embodiment illustrated in FIG. 1 specifically concerns the realization of the open wall structure 40.

The wall structure illustrated in FIG. 2 essentially consists of rods 41 attached in the illustrated example to the portions 51 and 52 having a closed wall structure. Alternatively, an attachment to the transverse discs 61 and 62 is conceivable and possible.

In contrast to the embodiment illustrated in FIG. 1, the open wall structure 40 has a larger outer diameter DW than the neighboring portions 51 and 52 of the screw hub 15. In other words, the outer diameter DI of the neighboring portions 51 and 52 of the screw hub is smaller than the outer diameter DW of the open wall structure 40.

Due to the increased outer diameter DW, the rods 41 of the open wall structure 40 may better immerge into the material located within the drum or the pond. The ratio of the outer diameter DW of the open wall structure 40 to the outer diameter of the screw spiral 20 preferably is 0.8-0.4.

It should be pointed out in conclusion that all of the features mentioned in the application documents and in particular in the dependent claims, despite the performed formal back reference to one or several certain claims, should have an independent protection even singly or in an arbitrary combination.

### LIST OF REFERENCE NUMERALS

10 centrifugal screw
11 cylindrical longitudinal portion
12 portion at the solid-discharge end
15 screw hub
18 cone shape
20 screw spiral
31 first frontal side
32 second frontal side
35′ bearing portion
40 open wall structure
41 longitudinal rod
50 middle segment
51 first portion of closed wall structure
52 second portion of closed wall structure
61 first transverse disc
62 second transverse disc
63 opening
A perpendicular
DS outer diameter of screw spiral
DI outer diameter of portions of the cylindrical longitudinal portion
DW outer diameter of open wall structure
GL total length of the cylindrical longitudinal portion
L longitudinal axis
LW length of open wall structure
R longitudinal direction

1. A centrifugal screw (10) having a screw hub (15) and a screw spiral (20) connected to the screw hub (15), wherein the screw hub (15) in the longitudinal direction (R) has at least one cylindrical longitudinal portion (11) and a portion (12) at the solid-discharge end,
characterized in that
in the cylindrical longitudinal portion (11), an open wall structure (40) is designed only in sections, wherein the open wall structure (40) extends in the cylindrical longitudinal portion (11) at most over a length (LW) of 50% of the total length (GL) of the cylindrical longitudinal portion (11).

2. The centrifugal screw (10) according to claim 1,
characterized in that
the open wall structure (40) in the cylindrical longitudinal portion (11) extends at most over a length (LW) of 45% of the total length (GL) of the cylindrical longitudinal portion (11), in particular at most over a length (LW) of 35% of the total length (GL) of the cylindrical longitudinal portion (11), particularly preferred at most over a length (LW) of 25% of the total length (GL) of the cylindrical longitudinal portion (11).

3. The centrifugal screw (10) according to claim 1 or 2,
characterized in that
the open wall structure (40) is designed to be spaced from both ends, in particular from both frontal sides (31, 32) of the screw hub (15), in particular to be a middle segment.

4. The centrifugal screw (10) according to claim 1,
characterized in that
the open wall structure (40) has a larger outer diameter (DW) than neighbouring portions (51, 51) of the screw hub (15), in particular has the largest outer diameter of the screw hub (15).

5. The centrifugal screw (10) according to claim 1,
characterized in that
a ratio of a/the outer diameter (DW) of the open wall structure (40) to the outer diameter (DS) of the screw spiral (20) is 0.8-0.4, in particular 0.7-0.4, particularly preferred 0.4.

6. The centrifugal screw (10) according to claim 1,
characterized in that
the open wall structure (40) is formed so as to have several longitudinal rods (41) running in the longitudinal direction (R).

7. The centrifugal screw (10) according to claim 1,
characterized in that
the open wall structure (40) is formed by a plurality of web elements delimiting a plurality of openings, wherein the web elements with respect to the longitudinal axis (L) of the screw hub (15) are arranged radially outside and form a circumference of the cylindrical longitudinal portion (11), wherein two web elements respectively form a web pair delimiting at least one opening, wherein the two web elements of the web pair extend in the longitudinal direction (R) and transversely to the longitudinal direction (R), or a first web element of the web pair respectively extends in the longitudinal direction (R), and a second web element of the web pair extends transversely to the longitudinal direction (R).

8. The centrifugal screw (10) according to claim 1,
characterized in that
the open wall structure (40) at least in sections is formed by a tube in which a plurality of openings is designed for the passage of a medium, wherein the openings each have a longitudinal extension which is larger than the width of the respective opening.

9. The centrifugal screw (10) according to claim 1,
characterized in that
the portion (12) at the solid-discharge end has a cone shape or a double truncated cone shape or is designed to be a cylindrical portion or a cylindrical tube portion.

10. The centrifugal screw (10) according to claim 1,
characterized in that
the open wall structure (40) is designed in an inflow area of the centrifugal screw (80), wherein an inflow tube opening of an inflow tube opens into the inflow area, wherein a baffle element, in particular a baffle disc, having an acceleration element is designed opposite the inflow tube opening, wherein the acceleration element is designed such that a medium impinging on the acceleration element can be accelerated in the direction of openings of the open wall structure (40).

11. The centrifugal screw (10) according to claim 10,
characterized in that
the inflow tube extends starting from the portion (12) at the solid-discharge end in the direction of the inflow area.

12. A solid bowl screw centrifuge comprising a centrifugal screw (10) located within a drum, wherein the centrifugal screw (10) is designed according to claim 1.
